(19) United States
(12) Patent Application Publication
(10) Pub. No.: US 2017/0259414 A1
(43) Pub. Date: Sep. 14, 2017

(54) ADJUSTMENT TOOL

(71) Applicant: Océ Holding B.V., Venlo (NL)

(72) Inventor: Rob HOOGENDIJK, Venlo (NL)

(73) Assignee: Océ Holding B.V., Venlo (NL)

(21) Appl. No.: 15/443,528

(22) Filed: Feb. 27, 2017

(30) Foreign Application Priority Data
Mar. 9, 2016 (EP) 16159299.3

(51) Int. Cl. B25B 23/147; B41J 25/00; B41J 25/308; B25B 21/00

(52) U.S. Cl. CPC B25B 23/147; B25B 21/002; B41J 25/001; B41J 25/308

(57) ABSTRACT

An adjustment tool for adjustment operations on a machine has at least one mechanical adjustment member. The tool comprises a body, a tool head and a drive member. The tool head is mounted on the body and is adapted to be detachably coupled to the adjustment member. Further, the tool head is displaceable relative to the body. The drive member is configured for driving the tool head and the adjustment member coupled thereto. The adjustment tool further comprises a displacement limiter arranged to limit an amount of displacement which the drive member can impart on the tool head to a set value.

The invention relates to an adjustment tool for adjustment operations on a machine having at least one mechanical adjustment member, the tool comprising:
a body;
a tool head mounted on the body and adapted to be detachably coupled to the adjustment member, the tool head being displaceable relative to the body; and
a drive member for driving the tool head and the adjustment member coupled thereto.

More particularly, in an exemplary embodiment, the invention relates to an adjustment tool for adjusting a component, e.g. a print head, in an image reproduction apparatus such as a copier or printer, but the tool may be used with any kind of machine in which an adjustment member needs to be set, as apparent to those skilled in the art.

The print heads of an image reproduction apparatus have to be positioned with high accuracy in order to obtain a high print quality. Typically, the apparatus is tested and the print heads are adjusted by the manufacturer before the apparatus is delivered to the customer. Each print head has a number of adjustment members, e.g. adjustment screws, which permit to adjust the positions of each print head relative to the machine frame in several degrees of freedom. The manufacturer keeps a record on the adjustment operations, e.g. a number of turns and/or the angle by which the adjustment screw has been displaced from a given zero position, so that it is possible to reproduce the original adjusted position of the print head in case that the print head has to be replaced or re-installed after repair.

Since such a re-adjustment operation is a relatively rare event, the adjustment is normally done manually, e.g. by means of a screw driver. This, however, has the drawback that the amount of displacement, i.e. the angle of rotation, can only be determined with low accuracy by manually operating the screw driver.

A higher accuracy could be achieved if the adjustment operations were automated. In that case, it would however be necessary to provide an extra drive motor for each adjustment member of the machine, so that substantial costs would be incurred.

It is an object of the invention to provide an adjustment tool that permits a manual adjustment operation with improved accuracy.

According to the invention, in order to achieve this object, the tool comprises a set value defining unit for defining a set value indicating a predetermined amount of displacement for the tool head and a displacement limiter arranged to limit an amount of displacement which the drive member in operation imparts on the tool head to the set value.

In order to perform an adjustment operation, the necessary amount of displacement of the adjustment member, e.g. the amount of rotation of an adjustment screw, is set in advance in the set value defining unit. Then, when the drive member is operated in order to displace the tool head, the displacement limiter will assure that the amount of displacement is limited to the set value with high accuracy.

The degree of accuracy that can be achieved in this way is comparable to the accuracy that would be achievable with a fully automated adjustment system. However, since one and the same adjustment tool according to the invention can be used for different adjustment members of the machine and even for different machines, the costs are significantly lower than the costs for a fully automated solution.

It is noted that automatic tools are known that are configured to stop displacing an adjustment member as soon as a certain torque, or the like, is exceeded. Such a tool is not usable in the present application of adjusting and calibrating an element position. The amount of displacement is predetermined and predefined and not related to the operation of the tool. Moreover, torque controlled tools do not define and control an amount of displacement, but are merely suitable to prevent damage to the adjustment member due to an excessive force exerted by the tool. Hence, such tool is only usable for operating on screws, and the like, that need to be fastened without exceeding a predefined threshold and not for displacing a predefined amount, i.e. a predefined set value.

More specific optional features of the invention are indicated in the dependent claims. It is noted that hereinbelow the present invention may be further elucidated and explained with reference to an image reproduction apparatus, which is an exemplary embodiment for a machine, having a print head as an exemplary embodiment of an element requiring adjustment. As apparent to those skilled in the art and as above mentioned, the adjustment tool is usable with any other kind of machine in which an adjustment member needs to be set.

The tool head may be a screw driver blade which can be used for adjustment members in the form of adjustment screws.

In one embodiment, the drive member is an electric servo motor and the displacement limiter is implemented in a servo controller, so that the motor can be controlled to displace the tool head by the set amount.

Preferably, the drive member is arranged to drive the tool head in opposite directions, and separate displacement limiters are provided for limiting the displacement in each direction. This is useful for adjustment operations in which the adjustment member, e.g. an adjustment screw, is first rotated in a first direction (e.g. counter-clockwise) a certain number of turns and is then rotated by a certain angle in the opposite direction (clockwise). Adjustment operations of this kind are frequently used in order to avoid hysteresis effects in the adjustment mechanism.

The settings for the displacement limiter may be input manually into the servo controller, e.g. by means of a key pad. In a preferred embodiment, however, the settings are stored in a control system of the machine, and the servo controller in the adjustment tool is capable of communicating with the machine control system via a wireless or wireline link, so that the appropriate settings for each adjustment member of the machine may automatically be loaded into the servo controller.

In another embodiment, relevant information is encoded, e.g. in the form of a bar code, a QR code or an RFID-chip, in a tag that is applied to the machine, preferably in the vicinity of the adjustment member to which the relevant information applies, and the adjustment tool has a tag reader capable of reading the tag. In that case, the tag reader may be used for checking whether the adjustment tool is coupled to a correct adjustment member and held in the correct position relative to the machine during the adjustment operation. In another embodiment, the relevant information retrieved from the tag may be used to retrieve the appropriate settings (e.g. set value) for the coupled adjustment member, for example from a machine control system via a wireless or wireline link as above described.

The adjustment tool may also comprise a display for displaying instructions and other information to the user. When the settings for a plurality of adjustment members have been loaded into the tool, the display may indicate which of the adjustment members is to be adjusted next in order to assure that the correct settings are applied to each adjustment member. The information may for example be displayed in the form of an image of the adjustment member and its surroundings, which also makes it easier for the user to locate the adjustment members on the machine. Such a display also helps to assure that none of the adjustment members is left out in the adjustment process.

The drive member of the adjustment tool does not have to be a power driven device such as an electric motor but may also be a manually operated device. In that case, the set value defining unit and the displacement limiter may for example comprise an electronic clutch which couples the drive member to the tool head, an encoder measuring the amount of displacement of the drive member relative to the body, and an electronic controller programmed to disengage the clutch when the set amount of displacement has been reached. A tool of this kind has a relatively small power consumption, so that a battery inside the body of the tool will last longer.

The adjustment tool according to the invention may also be a purely mechanical tool in which the displacement limiter is constituted by a manually operated mechanism for limiting the amount of displacement.

Embodiment examples will now be described in conjunction with the drawings, wherein:

FIG. 1 is a view of an adjustment tool according to a first embodiment of the invention shown together with an adjustment member of a machine to be adjusted:

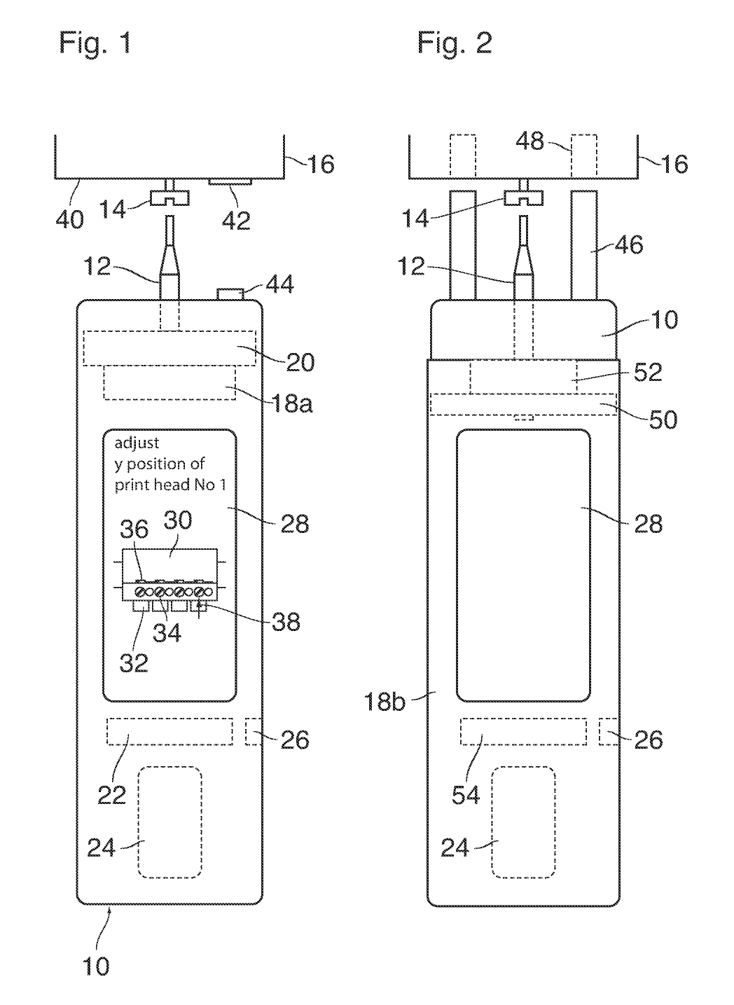

FIG. 2 is a view of an adjustment tool according to another embodiment;

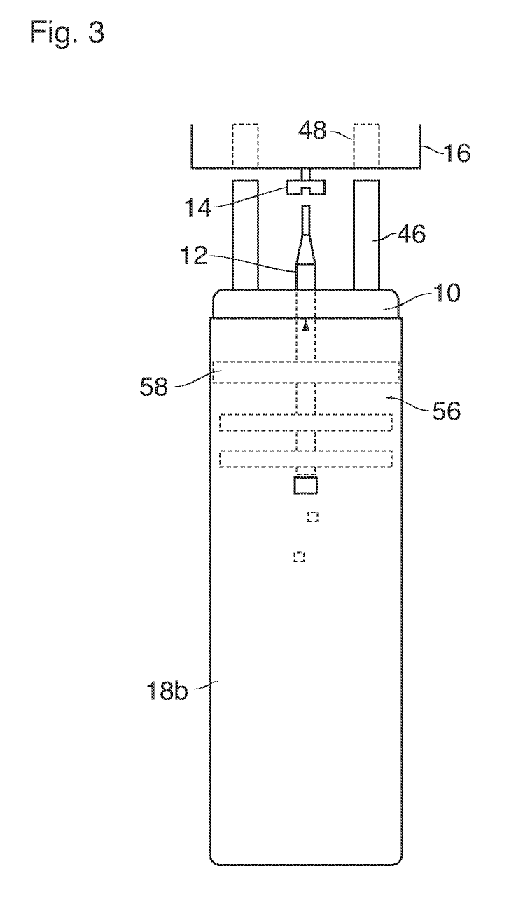

FIGS. 3 to 5 are views of a purely mechanical adjustment tool in three

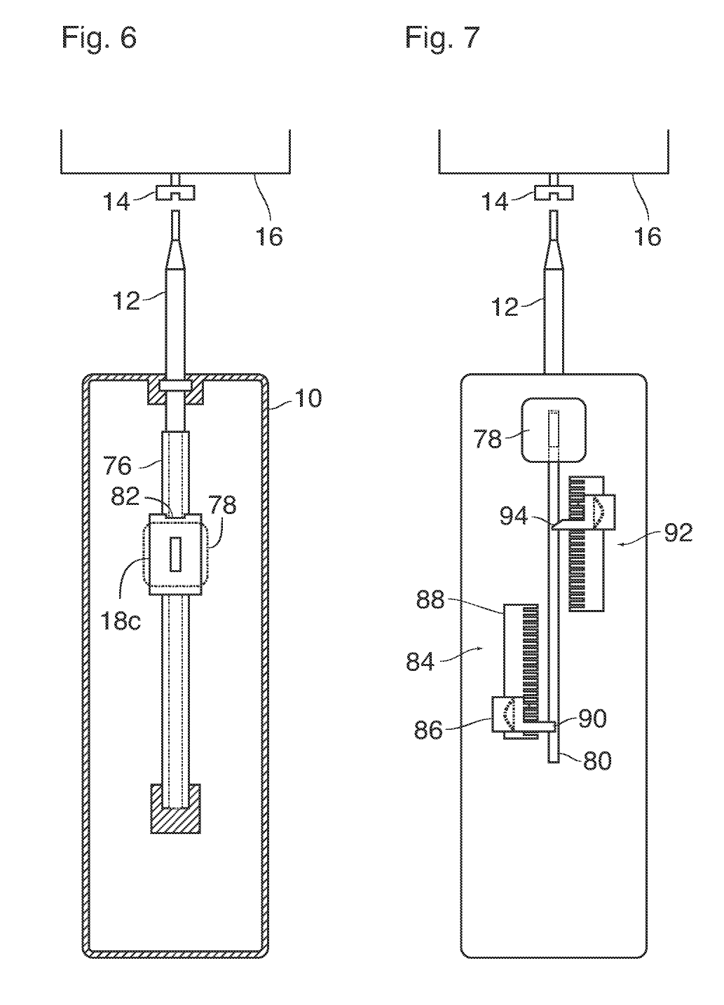

FIGS. 6 and 7 are a sectional view and a side view, respectively, of a mechanical adjustment tool according to another embodiment.

As is shown in FIG. 1, an adjustment tool has an elongated body 10 of a size and shape suitable for a user to hold the tool in his hand. A tool head 12 in the form of a screw driver blade projects from a front end of the body 10 so that it may be brought into engagement with an adjustment member 14, in this case an adjustment screw, that is provided on a part of a machine 16. For example, the machine 16 may be a printer, and the adjustment member 14 may be provided on a print head carriage for adjusting the position of the print head relative to the carriage in a certain direction y.

The tool head 14 is rotatably supported in the body 10 and is connected to a drive member 18a via a transmission 20. In this example, a drive member 18a is an electric servo motor.

The body 10 further accommodates an electronic servo controller 22 for controlling the servo motor, and a battery 24 for powering the servo motor and the servo controller 22.

A set value defining unit comprises a communication interface 26 connected to the servo controller 22 and permitting wireless or wireline communication between the servo controller 22 and an electronic control system (not shown) of the machine 16.

A display screen 28 is provided on one of the larger outer surfaces of the body 10 and is controlled by the servo controller 22 for displaying information to the user. In the given example, the display 28 shows a written instruction informing the user that the next adjustment member 14 of the machine 16 to be adjusted is an adjustment screw for adjusting the y position of a print head No. 1. Further, the screen shows an image of the print head carriage 30 with four print heads 32 mounted thereon as well as a number of adjustment screws 34, 36 for adjusting the print heads 32 in directions y and z, respectively. An arrow 38 marks the particular adjustment member 14 (one of the adjustment screws 34) that is next to be adjusted.

When the adjustment tool is brought into the vicinity of the machine 16, the communication interface 26 establishes a link, preferably automatically, between the servo controller 22 and the control system of the machine 16, and the adjustment settings (e.g. set value) for all the adjustment screws 34, 36 are downloaded into the servo controller 22. For example, it may be assumed that all adjustment screws are initially in a zero position, e.g. a position where the head of the adjustment screw engages an abutment surface 40 at the machine. In another example, a calibration procedure has been initiated by determining an offset for each adjustment screw e.g. by use of a printed test image and determining a positional inaccuracy from the printed test image. Then, the adjustment settings comprise, for each of the adjustment screws 34, 36, a number of turns by which the adjustment screw is to be rotated counter-clockwise and then a certain angle by which the adjustment screw is subsequently to be turned clockwise in order to reach the final adjustment position. Via the display screen 28, the servo controller 22 will then prompt the user to perform the adjustment operations for each of the adjustment screws 34, 36 one after the other or, if multiple tool heads are available for mating with multiple adjustment screws simultaneously, the adjustment operation may be performed for each of the adjustment screws 34, 36 all at once.

When the user has brought the tool head 12 into engagement with the slot of the adjustment member 14 in the zero position, the user may press a button (not shown) on the body 10 or may give a start signal by pushing the body 10 and the tool head 12 against the adjustment member 14 with a certain force, which causes the servo controller 22 to control the drive member 18 to perform the prescribed number of counter-clockwise turns and then to rotate the tool head 12 clockwise by the prescribed angle. This operation will then be repeated for each adjustment screw.

In the example shown in FIG. 1, a tag 42 is attached to the machine 16 in the vicinity of the adjustment member 14, and the adjustment tool has a tag reader 44 arranged to detect and read the tag 42. The tag 42 and the tag reader 44 may for example be used for checking whether the body 10 is held in the correct orientation relative to the machine 16 during the adjustment operation. Optionally, the adjustment settings for the adjustment member 14 may be encoded on the associated tag 42 and may be read with the tag reader 44. In this case, the communication interface 26 would not be needed for downloading the adjustment settings (e.g. set value). It may however be used for downloading data that identify the adjustment screws 34, 36 of the machine and permit to generate the images to be displayed on the screen 28.

FIG. 2 illustrates a modified embodiment in which a drive member 18b is formed by a sleeve that is rotatably supported on the body 10. The body 10 has a coupling member 46 constituted by two pins that project from the front end of the body 10 beyond the tool head 12. The machine 16 has a reference structure 48 in the form of two blind bores that are complementary to the coupling member 46. When the tool head 12 is inserted into the slot of the adjustment member 14, the coupling member 46 engages the reference structure 48, so that the body 10 is held in a well defined position relative to the machine 16 and is locked against rotation.

The sleeve-like drive member 18b is internally provided with an electric clutch 50 and an encoder 52. The clutch 50 can be brought into engagement with the tool head 12, and the encoder 52 measures the amount of rotation of the drive member 18b relative to the body 10. Both, the clutch 50 and the encoder 52 are connected to an electronic controller 54 which is accommodated in the drive member 18b just as the battery 24, the communication interface 26 and the display screen 28.

When the coupling member 46 and the tool head 12 have been brought into engagement with the reference structure 48 and the adjustment member 14, respectively, the drive member 18b is manually turned counter-clockwise, for example. The tool head 12 is driven via the clutch 50 and the adjustment member 14 is rotated. The encoder 52 counts the amount of rotation and when the set value for the counter-clockwise rotation has been reached, the controller 54 disengages the clutch 50, so that the rotation of the tool head 12 stops.

In this condition, however, the clutch 50 still operates as a one-way clutch that permits to drive the tool head 12 in clockwise direction. Accordingly, when the drive member 18b is turned clockwise, the adjustment member 14 is also driven clockwise, and the amount of rotation is again counted by the encoder 52. When the set amount has been reached, the clutch 50 is totally disengaged from the tool head 12, so that the adjustment member is rotated exactly by the pre-set amount.

FIGS. 3 to 5 show an embodiment which differs from the embodiment shown in FIG. 2 in that the electric clutch 50 has been replaced by a mechanical clutch mechanism 56.

The sleeve-like drive member 18b is movable relative to the body 10 also in axial direction. In FIG. 3, the drive member 18b is held in an axial position in which it is rigidly coupled to the tool head 12 via an input clutch member 58. In this condition, the tool can be used like a normal screw driver.

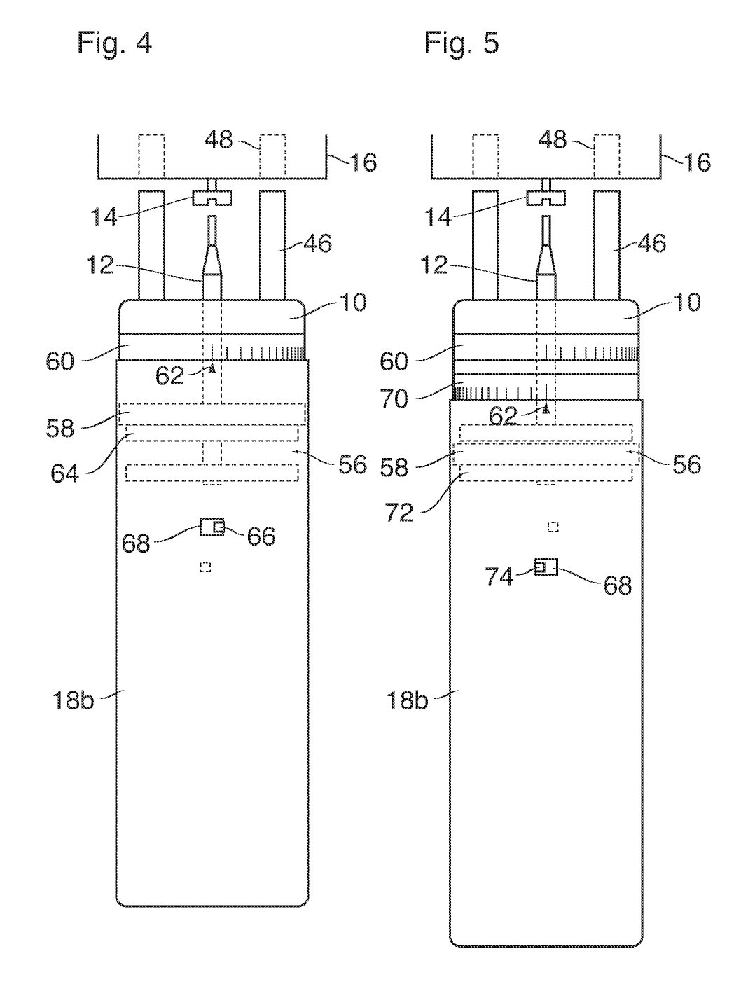

In FIG. 4, the drive member 18b has been moved axially into a first adjustment position in which a first scale 60 becomes visible on the body 10. A mark 62 on the drive member 18b is aligned with a zero position on the scale 60. The input clutch member 58 is coupled to a first output clutch member 64 such that both members together constitute a one-way clutch which transmits the rotation of the drive member 18b onto the tool head 12 only when the drive member is rotated counter-clockwise.

A first catch 66 on the body 10 is in engagement with a window 68 formed in the peripheral wall of the drive member 18b.

In order to prepare the tool for a first adjustment operation in counter-clockwise direction, the drive member 18b is rotated clockwise from the zero position shown in FIG. 4 until the mark 62 points to a value on the scale 60 that corresponds to the set adjustment amount. During this clockwise rotation, the one-way clutch leaves the tool head 12 stationary. Then, the drive member 18b is rotated counter-clockwise, until the zero position is reached again and the catch 66 snaps-in at the window 68 to limit the rotation. During this phase, the one way clutch drives the tool head 12, so that the adjustment member 14 is rotated counter-clockwise by the required amount.

Then, in order to prepare the tool for a second adjustment operation in clockwise direction, the drive member 18b is slid to the position shown in FIG. 5. Here, a second scale 70 on the body 10 becomes visible, and the mark 62 points to the zero position on that scale. The input clutch member 58 is in engagement with a second output clutch member 72 and these members constitute a one-way clutch which is engages only during clockwise rotation. The window 68 of the drive member is now in engagement with a second catch 74 on the body 10.

The drive member 18 is now rotated in counter-clockwise direction until the mark 62 points to a value on the scale 70 that corresponds to the set amount for the adjustment in clockwise direction. Then, when the drive member 18 is turned back towards the zero position, the one way clutch engages and the tool head 12 and the adjustment member 14 are driven until the drive member 18b reaches again the zero position and the rotation is stopped by the second catch 74 snapping-in at the window 68.

FIGS. 6 and 7 show another embodiment of a purely mechanical tool.

As is shown in FIG. 6, the tool head 12 is again rotatably supported in the body 10 and has a prolonged shaft which constitutes a spindle 76 inside of the body 10. A drive member 18c is constituted by a nut that is in engagement with the spindle 76 and is movable in axial direction along the spindle in order to drive the spindle and the tool head for rotation relative to the body 10.

As is shown in FIG. 7, the drive member 18c has a tab 78 disposed on the outer surface of the body 10 and connected to the spindle through a slot 80 formed in the wall of the body 10.

In the position shown in FIG. 7, the tool head 12 engages a notch 82 (FIG. 6) of the drive member 18c, so that the tool head 12 and the body 10 are coupled for joint rotation. In this state, the tool can be used as a normal screw driver.

A first displacement limiter 84 is constituted by a slide 86 that is slidable in a slot 88 of the body 10 and forms a stop 90 for the tab 78. The slide 86 is elastically biased to engage a notched edge of the slot 88.

A second displacement limiter 92 for the displacement in opposite direction has the same constitution as the first displacement limiter 84, with the only difference that its stop 94 can be overridden when the tab 78 moves downward.

In order to prepare the tool for an adjustment operation, the slide 86 of the first displacement limiter 84 is slid in the slot 88 and brought into engagement with the notched edge in a set position that defines the required amount of displacement. Similarly, the slide of the second displacement limiter 92 is slid to a position defining the amount of adjustment in the clockwise direction. Then, the tool head 12 is brought into engagement with the adjustment member 14 and the tab 78 is pulled back (e.g. with a thumb) so that the drive member 18c moves downward and the tool head 12 is rotated counter-clockwise. This rotation is terminated when the tab 78 reaches the stop 90.

Then, the tab 78 is pushed forward again, so that the tool head 12 and the adjustment member 14 are rotated clockwise until the tab 78 abuts at the stop 94 which cannot be overridden in this direction. In order to restitute the initial condition, the slide of the second displacement limiter 92 may be pulled away from the notched edge of the slot manually, so that the tab 78 can be pushed forward to the position shown in FIG. 7.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims is herewith disclosed.

Further, it is contemplated that structural elements may be generated by application of three-dimensional (3D) printing techniques. Therefore, any reference to a structural element is intended to encompass any computer executable instructions that instruct a computer to generate such a structural element by three-dimensional printing techniques or similar computer controlled manufacturing techniques. Furthermore, such a reference to a structural element encompasses a computer readable medium carrying such computer executable instructions.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An adjustment tool for adjustment operations on a machine having at least one mechanical adjustment member, the tool comprising:
a body;
a tool head mounted on the body and adapted to be detachably coupled to the adjustment member, the tool head being displaceable relative to the body;
a drive member for driving the tool head and the adjustment member coupled thereto;
a set value defining unit for defining a set value indicating a predetermined amount of displacement for the tool head; and
a displacement limiter arranged to limit an amount of displacement which the drive member in operation imparts on the tool head to the set value.

2. The tool according to claim 1, wherein the drive member is arranged to rotate the tool head relative to the body.

3. The tool according to claim 1, wherein the drive member is a servo motor and the displacement limiter is constituted by an electronic servo controller.

4. The tool according to claim 1, wherein the drive member is a member that is arranged for being driven manually, and the displacement limiter is constituted by an encoder arranged for measuring the amount of displacement of the tool head relative to the body, an electric clutch arranged to selectively couple the drive member to the tool head, and an electronic controller for controlling the clutch on the basis of signals received from the encoder.

5. The tool according to claim 1, wherein the set value defining unit comprises a communication interface configured for wireless or wireline communication with a control system of the machine.

6. The tool according to claim 1, wherein the set value defining unit comprises a user interface configured for receiving the set value from a user.

7. The tool according to claim 1, comprising a display screen and a controller configured for displaying information related to the adjustment operation on the screen.

8. The tool according to claim 7, wherein the controller is arranged to display an image showing where the adjustment member to be adjusted is located on the machine.

9. The tool according to claim 1, wherein the set value defining unit comprises a tag reader arranged on the body for detecting and reading a tag on the machine.

10. The tool according to claim 9, wherein the tag reader and the controller are configured to derive set values for the amount of displacement by decoding information that is read by the tag reader.

11. The tool according to claim 1, wherein the body has a coupling member configured for being brought into engagement with a reference structure on the machine.

12. The tool according to claim 1, wherein the set value defining unit and the displacement limiter are purely mechanical, manually operated devices.

13. The tool according to claim 1, wherein the tool is configured to apply the amount of displacement in at least two opposite directions, the tool comprising two displacement limiters for limiting the amounts of displacement of the tool head in each of the at least two opposite directions.
